(19) United States
(12) Patent Application Publication
(10) Pub. No.: US 2022/0340844 A1
(43) Pub. Date: Oct. 27, 2022

(54) LAUNDRY DETERGENT COMPOSITION

(71) Applicant: Church & Dwight Co., Inc., Princeton, NJ (US)

(72) Inventor: Robert T. Zehr, Somerset, NJ (US)

(73) Assignee: Church & Dwight Co., Inc., Princeton, NJ (US)

(21) Appl. No.: 17/237,880

(22) Filed: Apr. 22, 2021

(51) Int. Cl. C11D 11/00; C11D 17/04; C11D 1/83; C11D 3/00; C11D 3/20; C11D 3/30; C11D 3/37; C11D 10/04

(52) U.S. Cl. CPC C11D 11/0017; C11D 17/043; C11D 1/83; C11D 3/0026; C11D 3/2065; C11D 3/2068; C11D 3/30; C11D 3/373; C11D 10/045; C11D 1/72

(57) ABSTRACT

An article is provided herein which includes an aqueous liquid detergent and a package for the aqueous liquid detergent which is in direct contact with the aqueous liquid detergent, wherein the package is formed from a water-soluble, film-forming material. The aqueous liquid detergent includes at least one non-linear surfactant.

### FIELD OF THE INVENTION

The present disclosure relates to compositions for use in laundry machines, and more particularly to an aqueous liquid detergent composition.

### BACKGROUND

This present disclosure relates to liquid laundry detergents in unit dosage form in a package comprising a water-soluble, film-forming material.

The use of water-soluble film packages to deliver unit dosage amounts of laundry products is well known. Granular detergents and granular bleaches have been sold in this form in the United States for many years. A compact granular detergent composition in a water-soluble film pouch has been described in Japanese Patent Application No. 61-151032, filed Jun. 27, 1986, which is incorporated herein by reference. A paste detergent composition packaged in a water-soluble film is disclosed in Japanese Patent Application No. 61-151029, also filed Jun. 27, 1986. Further disclosures relating to detergent compositions which are either pastes, gels, slurries, or mulls packaged in water-soluble films can be found in U.S. Pat. Nos. 8,669,220 to Huber et al.; U.S. Pat. App. Pub. Nos. 2002/0033004 to Edwards et al., 2007/0157572 to Oehms et al., and 2012/0097193 to Rossetto et al.; Canadian Patent No. 1,112,534 issued Nov. 17, 1981; and European Patent Application Nos. 158464 published Oct. 16, 1985 and 234867, published Sep. 2, 1987; each of which is incorporated herein by reference. A liquid laundry detergent containing detergents in a water/propylene glycol solution is disclosed in U.S. Pat. No. 4,973,416, which is herein incorporated by reference. See, also, U.S. Pat. No. 7,915,213 to Adamy et al. and U.S. Pat. App. Pub. No. 2006/0281658 to Kellar et al., which disclose high builder compositions in pods and are both herein incorporated by reference.

It is generally believed that high water content liquid laundry detergents are incompatible with water-soluble films because of their water content. Thus, the attendant advantages of high water content liquid laundry detergents over other forms of laundry detergents such as granules, pastes, gels, and mulls have not been readily available in water-soluble unit dosage form. The advantages of liquid laundry detergents over granules, pastes, gels, and mulls include their aesthetic appearance and the faster delivery and dispersibility of the detergent ingredients to the laundry wash liquor, especially in a cool or cold water washing process.

However, one issue encountered with liquid laundry detergents is that liquid detergent formulations are susceptible to instability under extended freeze/thaw and high/low temperature conditions. It is known in the art that manufacturers of consumer laundry washing machines have sought increased energy efficacy for their machines by continually reducing the water temperature during the wash. This decades long trend has led to lower average washing temperatures that strongly affects the efficacy of laundry detergent and overall cleanliness and hygiene. One notable difficulty is that many surfactants, which are used in laundry detergent formulations for their cleaning properties and benefits, form a viscous gel phase when dissolved at lower temperatures, leading to incomplete dissolution of the detergent formulation, detergent staining of clothes, and ultimately, consumer complaints where the laundry detergent is blamed. Liquid detergent compositions require careful control of the surfactants used therein so as to prevent salting-out of the surfactant phase.

Accordingly, there is still a desire and a need to provide a stable, cold-water effective, liquid laundry detergent that is still suitable for use in forming dose packs or pods with a water-soluble, film-forming material, which is in direct contact with the liquid laundry detergent.

### SUMMARY OF THE INVENTION

In one aspect of the present disclosure, an aqueous liquid detergent is provided. An article is also provided herein, the article comprising an aqueous liquid detergent and a package for the aqueous liquid detergent which is in direct contact with the aqueous liquid detergent, wherein the package is formed from a water-soluble, film-forming material. In various embodiments, the water-soluble, film-forming material is polyvinyl alcohol. Embodiments of the detergent formulations disclosed herein aim to prevent or mitigate the problematic gel phase formation in concentrated formulas by incorporating a surfactant with a more bulky (branched as opposed to linear) hydrophobic tail that interferes with the molecular packing of surfactants at cold temperatures, thereby rendering the gel phase more fluid, or disrupting the gel phase formation entirely.

The invention includes, without limitation, the following embodiments.

Embodiment 1: An article comprising: an aqueous liquid detergent; and a package for the aqueous liquid detergent which is in direct contact with the aqueous liquid detergent, wherein the package is formed from a water-soluble, film-forming material; wherein the aqueous liquid detergent comprises at least one non-linear surfactant.

Embodiment 2: The article of Embodiment 1, wherein the non-linear surfactant is a nonionic surfactant.

Embodiment 3: The article of any of Embodiments 1-2, wherein the non-linear surfactant is a secondary alcohol ethoxylate.

Embodiment 4: The article of any of Embodiments 1-3, wherein the non-linear surfactant is present in an amount of about 35-50 weight percent, based on the total weight of the aqueous liquid detergent.

Embodiment 5: The article of any of Embodiments 1-4, further comprising a linear nonionic surfactant.

Embodiment 6: The article of Embodiment 5, wherein the linear nonionic surfactant is an alcohol ethoxlate.

Embodiment 7: The article of Embodiment 5, wherein the linear nonionic surfactant is an alkyl poly glucoside.

Embodiment 8: The article of any of Embodiments 5-7, wherein the linear nonionic surfactant is present in an amount of about 0-15 weight percent, based on the total weight of the aqueous liquid detergent.

Embodiment 9: The article of any of Embodiments 1-8, further comprising at least one anionic surfactant.

Embodiment 10: The article of Embodiments 9, wherein the at least one anionic surfactant is an alkyl ether sulfate.

Embodiment 11: The article of Embodiment 9, wherein the at least one anionic surfactant is a linear alkylbenzyl sulfonate.

Embodiment 12: The article of any of Embodiments 9-11, wherein the at least one anionic surfactant is present in an amount of about 5-25 weight percent, based on the total weight of the aqueous liquid detergent.

Embodiment 13: The article of any of Embodiments 1-12, further comprising at least one humectant.

Embodiment 14: The article of Embodiment 13, wherein the at least one humectant comprising glycerin, dipropylene glycol, or a combination thereof.

Embodiment 15: The article of any of Embodiments 1-14, further comprising at least one buffer.

Embodiment 16: The article of Embodiment 15, wherein the at least one buffer comprises monoethanolamine, triethanolamine, or a combination thereof.

Embodiment 17: The article of any of Embodiments 1-16, further comprising at least one anti-foaming agent.

Embodiment 18: The article of Embodiment 17, wherein the at least one anti-foaming agent comprises a sodium soap, a silicone, or a combination thereof

These and other features, aspects, and advantages of the disclosure will be apparent from a reading of the following detailed description together with the accompanying drawings, which are briefly described below. The present disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

Other aspects and advantages of the present disclosure will become apparent from the following.

### BRIEF DESCRIPTION OF THE DRAWINGS

FIG. 1 illustrates chemical formulas of surfactants useful in the detergent formulations described herein; and

FIG. 2 is a graph illustrating the dissolution properties of two detergent formulations in water at different temperatures.

### DETAILED DESCRIPTION OF THE INVENTION

The present disclosure now will be described more fully hereinafter with reference to the accompanying drawings. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

In one aspect of the present disclosure, an article is provided, the article for use in the laundry process comprising an aqueous liquid detergent and a package for the aqueous liquid detergent. More particularly, the article is an aqueous, organic solvent free, liquid laundry detergent contained in a package, preferably a pouch or packet, containing a unit dose of the liquid laundry detergent, the package comprising a water soluble film-forming material that dissolves when placed in the laundry wash water so as to release the liquid laundry detergent. As used herein, terms such as “package”, “pod”, “pouch”, and the like can be used interchangeably to describe the water-soluble film forming the article enclosing liquid laundry detergents described herein. According to the present disclosure, the water-soluble film-forming material is in substantially direct contact with the liquid laundry detergent, with the film-forming material maintaining its structural integrity prior to external contact with an aqueous medium, such as a laundry wash liquor. The liquid detergent is capable of remaining homogeneous over a relatively wide temperature range, such as might be encountered in storage, and the pouch is capable of dissolution in water even after extended storage.

The water-soluble package of this disclosure can preferably be made from polyvinyl alcohol, but can also be cast from other water-soluble materials such as polyethylene oxide, methyl cellulose and mixtures thereof. Suitable water-soluble films are well known in the art and are commercially available from numerous sources.

The liquid laundry detergent package itself can be of any configuration, but conveniently may have a rectangular or square shape when viewed normally to the plane of its two longest dimensions. A rectangular or square packet is more easily manufactured and sealed than other configurations when using conventional packaging equipment. In various embodiments, a unit dose product according to the present disclosure can include about 10 to about 50 g, about 15 to about 40 g, or about 20 to about 30 g of liquid within the liquid laundry detergent package.

The liquid laundry detergent for use in this disclosure is formulated in a manner which makes it compatible with the water-soluble film for purposes of packing, shipping, storage, and use. Without being limited by theory, compatibility of the liquid laundry detergent with the water-soluble film can be achieved by the use of an appropriate salt in the liquid laundry detergent composition.

The liquid laundry detergent is a concentrated, heavy-duty liquid detergent which can contain at least about 5 weight percent of water, based on the weight of the overall detergent composition. In some embodiments, water can be present in an amount of at least about 5 weight percent, at least about 10 weight percent, at least about 15 weight percent, at least about 20 weight percent, or at least about 25 weight percent of water, based on the weight of the overall detergent composition. In some embodiments, water can be present in an amount of about 5 weight percent to about 35 weight percent, about 10 weight percent to about 25 weight percent, about 10 weight percent to about 20 weight percent, or about 5 weight percent to about 15 weight percent, based on the total weight of the detergent composition. Without intending to be limited by theory, it is noted that too high of a water content in the liquid laundry detergent may contribute to dissolution of the polyvinyl alcohol film intended to contain the formula before use. Unit dose laundry products can include a higher percentage of surfactants than liquid detergents that are not in a unit dose form to help counteract the dissolution of the PVOH film. Unit dose liquid laundry detergent formulations can also incorporate non-aqueous dilutants (e.g., glycerin and dipropylene glycol) to dissolve and contain the surfactants in the formula, as discussed in more detail below. It is further noted that the weight percentage of water calculated for the formulations described herein includes the residual water associated with different components of the formulation (e.g., the surfactants which have a percentage of active surfactant, the remainder being water).

As described herein, embodiments of the present disclosure relate to an aqueous liquid detergent, which can be encapsulated in a water-soluble package. In particular, various embodiments of the present disclosure relate to an aqueous liquid detergent comprising at least one surfactant which his characterized as including a hydrophobic tail that interferes with the molecular packing of surfactants at cold temperatures. The formulations are essentially homogenous (show substantially no phase separation) for an extended time period and temperature range. In certain embodiments, the detergent can be clear. In some embodiments, the detergents provided herein are not clear transparent liquids, but are rather turbid and similar in form to pastes or gels. Without being limited by theory, it is noted that varying the level of certain surfactant(s) (e.g., Steol®, an anionic surfactant) can affect the solubility of the carbonate builder in the detergent composition and thereby affect whether the detergent composition is clear or opaque. Similarly, certain enzymes can also affect whether the detergent composition is clear or opaque. While homogeneity of the formulations provides a desirable product appearance, phase separation can also be a product performance issue, since both phases in a phase-separated system may not disperse and dissolve rapidly during the wash cycle, although the formulation may have dispersed and dissolved rapidly before phase separation occurred.

In various embodiments, the detergent formulations described herein comprise at least one builder. One or more builders could be incorporated into the formulations described herein in a number of ways, such as, but not limited to, solubilization of builders in the aqueous portion of the formula, stabilized as a slurry in the liquid formula, or as a powder in a separate pod compartment in a multi-chamber pod.

Some embodiments of the aqueous liquid detergent compositions described herein can comprise at least one surfactant. For example, the detergent compositions can comprise a nonionic surfactant, an anionic surfactant, an amphoteric surfactant, or combinations thereof.

In some embodiments, it can be advantageous for a nonionic surfactant to be present in an amount of at least 50% by weight, at least about 60% by weight, at least about 70% by weight, or at least about 80% by weight (e.g., 80-85% nonionic surfactant), based on the total weight of surfactant employed. It is noted that the weight percentage of each surfactant in the detergent composition may differ from the percentage of active surfactant. As is understood by those skilled in the art, nonionic surfactants lower the critical micelle concentration, and achieve superior oil removal. This ratio of 50% or higher nonionic surfactant to total surfactant present can also act to minimize phase separation within the pouch, as well as to enhance detergency, particularly in hard water.

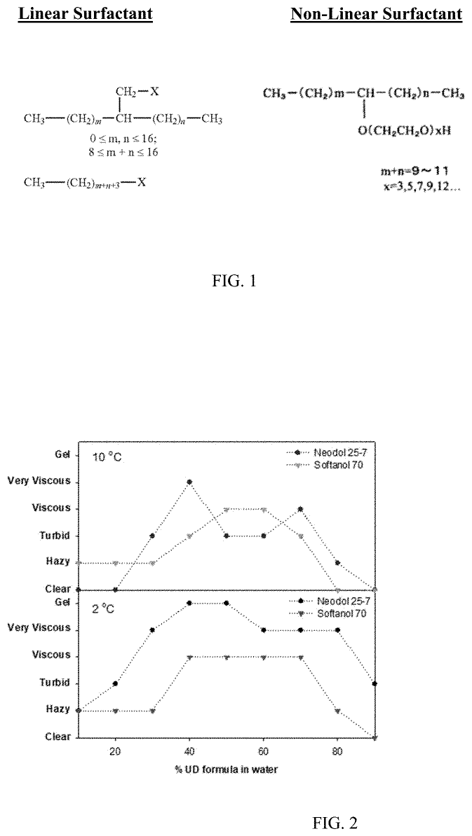

Embodiments of the detergent formulations described herein comprise at least one non-linear surfactant. As used herein, the term “non-linear surfactant” is intended to identify a surfactant wherein a hydrophilic substituent group is directly attached anywhere along the length of the hydrophobic chain. For example, the conventional C15 branched surfactant shown below is structurally different than the branched (e.g., Softanol™ series) surfactants useful in the formulations described herein. The chemical structures of the different surfactants are depicted in FIG. 1. The conventionally-used linear surfactant is a mixture of a linear (bottom left) and branched (top left) surfactant where the hydrophilic moiety is attached to the hydrophobic group through a methylene (—CH2—) linking group. In contrast, the non-linear surfactant useful in the detergent formulations described herein (right) has the hydrophilic group attached directly anywhere along the length of the hydrophobic group.

Without being intended to be limited by theory, the use of non-linear surfactants allows for the use of relatively high levels of nonionic surfactants, which are better suited to removing oily soils than their charged (i.e., anionic surfactant) counterparts, in the detergent formulations. The use of a non-linear surfactant was surprisingly found to provide relatively high solubility of the detergent formulation and thereby avoid the poor solubility traditionally associated with high concentrations of nonionic surfactants at low water temperatures. This in turn provides formulation flexibility as the use of a non-linear surfactant provides a way to overcome cold water gelling of concentrated detergent formulations.

In various embodiments, the non-linear surfactant can be an ethoxylate surfactant where the head group is attached anywhere along the hydrophobic tail (e.g., Softanol™ and/or the Tergitol™ 15-S series available from Dow®). Embodiments of the detergent formulations described herein can further include at least one additional surfactant (i.e., in addition to the at least one non-linear surfactant). In certain embodiments, the composition can comprise at least one surfactant selected from the group consisting of 12-15 carbon alcohol ethoxylate with 7 moles ethylene oxide per mole of alcohol (e.g., Neodol 25-7, Neodol 23-2 (C12-C13, 2 mol ethylene oxide), and other similar products available from Shell Global), 12-carbon alkylbenzene sulfonic acid neutralized with monoethanolamine, and sodium laureth sulfate having 2-5 moles ethylene oxide (e.g., Steol® products available from Stepan Company). In certain embodiments, the composition can comprise at least one surfactant selected from the group consisting of alkylpolyglucosides, alkyl ether sulfates, alkoxylated carboxylates, alkyldiphenyloxide disulfonates, and amphoterics (e.g. disodium cocoamphodipropionates, sodium alkyliminodipropionates, and disodium cocoamphodiacetates). An example of a disodium cocoamphodiacetate is Miranol C2M CONC NP (38.5% actives). In certain embodiments, the aqueous liquid detergent composition can comprise Steol® (an alkyl ether sulfate, an anionic surfactant) and Glucopon (an alkylpolyglucoside, a nonionic surfactant).

In certain embodiments, the formulations described herein include anionic surfactants (e.g., Steol® 25-3s 70/FC (70% active), which is the sodium salt of an alkyl ether sulfate, and Biosoft® S-118 (96.5% active), which is benzenesulfonic acid which is neutralized by the monoethanolamine present in the formulations described herein). Embodiments of the formulations described herein further include a nonionic surfactant (e.g., Neodal® 25-7, or Softanol 70 plus Neodol 23-2) in an amount of about 80-85 weight percent, based on the total weight of the surfactants. The nonionic surfactants used in certain embodiments of the formulations described herein are 100% active. The ratio of branched/nonlinear nonionic surfactant to (nominally) linear surfactant is about 70-80% nonlinear surfactant (e.g., Softanol 70) to about 20-30% linear nonionic surfactant (e.g., Neodol 23-2), based on the total weight of the nonionic surfactants present in the formulation. The ratio of nonlinear to linear nonionic surfactant can vary. In various embodiments, the nonlinear nonionic surfactant is present in an amount of about 50-100 wt. %, about 60-90 wt. %, or about 70-80 wt. %, based on the total weight of the nonionic surfactants present in the liquid detergent formulation.

In certain embodiments, the nonlinear surfactant can include an extended surfactant. Extended surfactants refer to a class of surfactants where oligomers of intermediate hydrophilicity (often butylene or propylene oxide polymers) have been inserted between the hydrophobic tail and the hydrophilic head group of a surfactant, thereby extending the so- called palisade region in a surfactant micelle structure. This “extended” micellar structure enhances the ability of the surfactant micelles to solubilize oils and can potentially enhance detergency and cleaning of oily surfaces. Extended surfactants have the following type of structure:

Tail-[X]ₓ-[—O—CH₂—CH₂-]_{y}-Head

In this scheme, “Tail” refers to the lipophilic tail group which is often a long chain hydrocarbon, “X” refers to the extender group which is often consists of short butylene or propylene oxide polymers, —O—CH2—CH2— refers to the ethylene oxide polymer section that provides some portion of the hydrophilicity of the surfactant, and finally “Head” refers to the head group proper which can range from hydrogen, hydroxyl, sulfonate, sulfate, carboxylate or many other hydrophilic species that are used in the detergent industry.

In various embodiments, the detergent compositions described herein comprise at least one anionic surfactant and at least one nonionic surfactant. The weight ratio of the nonionic surfactant to the anionic surfactant can be about 99:1 to about 70:30, or about 90:10 to about 75:25. In certain embodiments, the weight ratio of the nonionic surfactant to the anionic surfactant can be about 80:20, based on the percentage of each surfactant that is active. It is noted that commercially available surfactants may be diluted or mixed with additional ingredients beyond the surfactant actives (e.g., water). For consistency, the weight ratio of the surfactants is referring to the weight ratio of the surfactant actives.

In some embodiments, the detergent compositions described herein comprise at least one anionic surfactant and at least one amphoteric surfactant. The weight ratio of the anionic surfactant to the amphoteric surfactant can be about 99:1 to about 70:30, or about 90:10 to about 75:25 (based on the percentage of surfactant actives). In certain embodiments, weight ratio of the anionic surfactant to the amphoteric surfactant can be at least about 80:20, based on the percentage of each surfactant that is active. If an amphoteric surfactant is used, the weight ratio of the anionic surfactant to the amphoteric surfactant is preferably greater than 80:20 (based on the percentage of surfactant actives).

In various embodiments, the total amount of active surfactants in the detergent composition (i.e., anionic surfactant and nonionic and/or amphoteric surfactant) can be about 50-80 weight percent, about 60-75 weight percent, or about 65-75 weight percent, based on the total weight of the aqueous liquid detergent. In certain embodiments, the total amount of active surfactants in the detergent composition can be at least about 1% by weight, at least about 5% by weight, at least about 10% by weight, or at least about 15% by weight based on the total weight of the aqueous liquid detergent.

Various embodiments of the detergent formulations described herein comprise at least one chloride salt. For example, a formula comprising only potassium carbonate (i.e., no chloride salt) goes through a gel phase and then complete separation before reaching a final paste/slurry form. By adding a chloride salt to the detergent composition, the gel formation is eliminated and the phase separation is reduced, thereby easing the mixing/preparation process of detergent compositions according to the present disclosure. As such, embodiments of the aqueous detergent composition further comprise a chloride salt. Without being limited by theory, the chloride salt can help prevent and/or reduce the phase changes and separations caused by the builder in the detergent composition. In some embodiments, the chloride salt can comprise potassium chloride, sodium chloride, or combinations thereof. In certain embodiments, the chloride salt can be potassium chloride.

Various embodiments of the detergent compositions described herein can include additional ingredients conventionally found in detergent compositions. For example, the detergent compositions can include enzyme(s), dye(s), chelating agent(s), antiredeposition polymer(s), fluorescent whitening agent(s), fragrance(s), bittering agent(s), etc. For example, it was surprisingly discovered that high-pH-stable enzymes (e.g., stable at a pH of 12-13) can be useful in detergent compositions described herein. In general, additional ingredients in the liquid detergent compositions can be present in an amount of about 0.1 to about 10 weight percent, or about 1 to about 8 weight percent. In some embodiments, additional ingredients can be present in an amount of less than about 10 weight percent, less than about 8 weight percent, less than about 5 weight percent, less than about 3 weight percent, or less than about 1 weight percent, based on the total weight of the aqueous detergent composition.

A method of preparing an aqueous liquid detergent is also provided herein. In various embodiments, the method of preparing the detergent composition can comprise mixing the surfactants in an aqueous liquid medium to form a first mixture and adding the remaining ingredients to form the aqueous liquid detergent as a substantially homogeneous solution. It was surprisingly discovered that the order of addition of the components of the detergent composition can contribute to an increase in the ease of mixing and a decrease in undesirable phase changes and separations. Adding the surfactants early in the mixing process can be desirable. It is further noted that certain surfactants are sensitive to acidic conditions, which needs to be accounted for when such surfactants are used. For example, Steol 24-3s 70/FC is sensitive to acidic conditions. Biosoft S-118 is a strong sulfonic acid and either must be neutralized prior to adding the Steol or added to a rather basic formula containing Steol (e.g., Steol mixed with the base monoethanolamine).

In some embodiments, the method of preparing an aqueous liquid detergent can further include preparing a detergent article by placing a measured amount of the aqueous liquid detergent into a package for the aqueous liquid detergent. The package can be in direct contact with the aqueous liquid detergent. Furthermore, the package can be formed from a water-soluble, film-forming material, however, the film-forming material is insoluble with respect to the aqueous liquid detergent contained within the package. After placing a measured amount of the aqueous liquid detergent into the package, the water-soluble, film forming material of the package can be heat sealed in order to close the detergent within the package.

### EXPERIMENTAL

### Example 1

A detergent formulation comprising a non-linear surfactant (referred to herein as “non-linear formulation”) and a control detergent formulation comprising a linear surfactant (referred to herein as “linear formulation”) were prepared. The dissolution behavior of the two detergent formulations in water was measured and compared.

In this example, the cold water dissolution of a concentrated unit dose liquid detergent formulation was compared by switching from a primary alcohol ethoxylate (where the head group is attached at the 1 or 2 positions on the hydrophobe) in the control linear formulation to a secondary alcohol ethoxylate (where the head group can be attached anywhere along the hydrophobic tail) in the example non-linear formulation according to embodiments of the present disclosure. The weight percentages of the non-linear detergent formulation are provided in Table 1 below. The weight percentages of the components of the linear detergent formulation are provided in Table 2 below.

TABLE 1
An example of a non-linear detergent formulation

| Ingrediant/Function | Weight | Non-limiting Examples |
|---|---|---|
| Dilutant | 5-20 wt. | Water |
| Non-linear nonionic | 35-50 wt. | Secondary alcohol |
| surfactant(s) | | ethoxylates (Softanol) |
| Conventional nonionic | 0-15 wt. | Alcohol ethoxlates, |
| surfactant(s) | | Alkyl poly glucosides |
| Anionic surfactant(s) | 5-25 wt. | Alkyl ether sulfates, linear alkylbenzyl sulfonates |
| Humectants | 15-25 wt. | Glycerin, dipropylene glycol |
| pH control/Buffer | 1-5 wt. | Monoethanolamine, triethanolamine |
| Anti-foam | 0.1-5 wt. | Sodium soaps, silicones |
| Total | 100 | |

TABLE 2
An example of a linear detergent formulation

| Ingrediant/Function | Weight | Non-limiting Examples |
|---|---|---|
| Water | 5-20 wt. | Water |
| Conventional nonionic | 35-65 wt. | Alcohol ethoxlates, |
| surfactant(s) | | Alkyl poly glucosides |
| Anionic surfactant(s) | 5-25 wt. | Alkyl ether sulfates, linear alkylbenzyl sulfonates |
| Humectants | 15-25 wt. | Glycerin, dipropylene glycol |
| pH control/Buffer | 1-5 wt. | Monoethanolamine, triethanolamine |
| Anti-foam | 0.1-5 wt. | Sodium soaps, silicones |
| Total | 100 | |

The formulas were diluted with tap water to a varying degree (between 10% and 90% of the original concentration). The range of concentrations represents the formula in various stages of dissolutions from near the beginning (90% undiluted (UD)) to near the end where the sample is almost fully dissolved (10% UD). These multiple samples allowed for a simulation of the process of dilution with several discrete steps.

Samples were placed in a jacketed beaker hooked up to a controlled temperature cooling bath and gently stirred while the formulations were cooled to the specified temperature. Once the proper low temperature (10° C. & 2° C.) was reached, the stirring was stopped, and the sample was observed both visually and by using a spatula to qualitatively determine relative viscosity. The observations made were relative to the appearance and viscosity of the formulation at room temperature (which was always a clear liquid). Observations are ranked from the least change to the most detrimental change (gelation/solidification of sample) as shown in Table 3 below.

TABLE 3
Observation classifications

| Label | Observation |
|---|---|
| Clear | Fully Transparent |
| Hazy | Transparent, slight cloudiness |
| Turbid | Cloudy/Translucent |
| Viscous | Increased viscosity relative to room |
| | temperature, usually turbid |
| Very | Paste-like behavior, turbid |
| Viscous | |
| Gel | Stiff/no flow, turbid |

FIG. 2 maps the observed behavior of the diluted formulas based on formulation, concentration, and temperature with higher temperature (10° C.) on the top and lower temperature (2° C.) on the bottom chart.

The 10° C. data (top) in FIG. 2 show that the non-linear (i.e., Softanol) and linear (i.e., Neodol) based formulas behave relatively similar overall. The formulas are fairly stable at either end (low & high UD concentrations) of the dissolution curve but become more viscous near the middle of the curve. There is variability in the results at 40-70% UD (moderate to low dissolution levels) but the non-linear formula never becomes extremely viscous unlike the 40% linear sample.

The difference between the two surfactants is clearer in colder 2 ° C. (bottom) of the chart. Non-linear formulas containing Softanol 70 are far more fluid than the linear formulation samples at almost every dilution level. The increased fluidity means that the detergent will be more easily dispersed by the mechanical action of the washer, leading to better dissolution.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An article comprising:
an aqueous liquid detergent; and
a package for the aqueous liquid detergent which is in direct contact with the aqueous liquid detergent, wherein the package is formed from a water-soluble, film-forming material;
wherein the aqueous liquid detergent comprises at least one non-linear surfactant.

2. The article of claim 1, wherein the non-linear surfactant is a nonionic surfactant.

3. The article of claim 1, wherein the non-linear surfactant is a secondary alcohol ethoxylate.

4. The article of claim 1, wherein the non-linear surfactant is present in an amount of about 35-50 weight percent, based on the total weight of the aqueous liquid detergent.

5. The article of claim 1, further comprising a linear nonionic surfactant.

6. The article of claim 5, wherein the linear nonionic surfactant is an alcohol ethoxlate.

7. The article of claim 5, wherein the linear nonionic surfactant is an alkyl poly glucoside.

8. The article of claim 5, wherein the linear nonionic surfactant is present in an amount of about 0-15 weight percent, based on the total weight of the aqueous liquid detergent.

9. The article of claim 1, further comprising at least one anionic surfactant.

10. The article of claim 9, wherein the at least one anionic surfactant is an alkyl ether sulfate.

11. The article of claim 9, wherein the at least one anionic surfactant is a linear alkylbenzyl sulfonate.

12. The article of claim 9, wherein the at least one anionic surfactant is present in an amount of about 5-25 weight percent, based on the total weight of the aqueous liquid detergent.

13. The article of claim 1, further comprising at least one humectant.

14. The article of claim 13, wherein the at least one humectant comprising glycerin, dipropylene glycol, or a combination thereof.

15. The article of claim 1, further comprising at least one buffer.

16. The article of claim 15, wherein the at least one buffer comprises monoethanolamine, triethanolamine, or a combination thereof.

17. The article of claim 1, further comprising at least one anti-foaming agent.

18. The article of claim 17, wherein the at least one anti-foaming agent comprises a sodium soap, a silicone, or a combination thereof
